(19) United States
(12) Patent Application Publication
(10) Pub. No.: US 2010/0263631 A1
(43) Pub. Date: Oct. 21, 2010

(54) FUEL INJECTOR

(76) Inventor: Ferdinand Reiter, Markgroeningen (DE)

Correspondence Address: KENYON & KENYON LLP, ONE BROADWAY, NEW YORK, NY, 10004, US

(21) Appl. No.: 12/734,170

(22) PCT Filed: Sep. 24, 2008
(86) PCT No.: PCT/EP2008/062727

§ 371 Date: Jul. 1, 2010

(30) Foreign Application Priority Data
Oct. 18, 2007 (DE) 10 2007 049 945.2

(51) Int. Cl. F02M 51/06

(52) U.S. Cl. 123/472

(57) ABSTRACT

A fuel injector includes an excitable actuator in the form of an electromagnetic circuit having a magnetic coil, an outer magnetic circuit component and a movable armature for actuating a valve-closure member, which interacts with a valve seat provided on a valve seat body. The outer cup-shaped magnetic circuit component has a component bottom. On the side opposite the component bottom, a disk-shaped cover part is inserted into the outer magnetic circuit component. The coil space for the magnetic coil is bounded by the outer magnetic circuit component, the cover part and a thin-walled sleeve element.

### BACKGROUND OF THE INVENTION

1. Field of the Invention

The present invention relates to a fuel injector for a fuel injection system.

2. Description of Related Art

A fuel injector for fuel injection systems of internal combustion engine is known from published European patent document EP 0 487 199 A1, which has an excitable actuator in the form of an electromagnetic circuit having a magnetic coil, an outer magnetic circuit component and a movable armature for actuating a valve closure member, which interacts with a valve seat that is provided on a valve seat body. By contrast to most of the other known fuel injectors (FIG. 1 of EP 0 487 199 A1), the fuel injector has no tubular core used as fuel inlet connection and internal pole, that is surrounded by the magnetic coil. Instead, the outer magnetic circuit component is embodied to be cup-shaped, the magnetic circuit component being inserted in the valve in such a way that it is turned upside down over the magnetic coil. The electromagnetic circuit is closed by a closure part which is pushed into the magnetic circuit component from below. The movable armature is guided in the coil shell or in an internal opening of the closure part. The entire actuator is enclosed by a plastic extrusion coating, which also forms a connecting piece on the inflow side.

A fuel injector is also known from published German patent document DE 197 12 922 A1, in which a tubular core used as fuel inlet connection and internal pole, that is surrounded by the magnetic coil, is omitted. The fuel injector is characterized in that both the connecting piece on the inlet side and the connecting part used as valve seat support are developed as deep-drawn sheet metal parts. The sheet metal parts are formed by a deformation stress exceeding the yield point of their material, and are connected to one another to form a valve housing, using assembling pins.

### BRIEF SUMMARY OF THE INVENTION

The fuel injector according to the present invention has the advantage that an especially compact design in the region of the magnetic circuit as well as in the regions upstream and downstream of the magnetic circuit is able to be implemented in a simple and cost-effective manner, so that a very small, manageable fuel injector is created. The present invention describes a simple constructive design approach, which creates a sealed, tight coil space for coil sealing, in which a disk-shaped cover part, used as internal pole of the magnetic circuit is inserted into an outer magnetic circuit component, both the cover part and the magnetic circuit component being rigidly connected to a thin-walled sleeve element. The sleeve element, in this context, inwardly bounds the coil space for the magnetic coil. Since the components of the electromagnetic circuit, and also the connecting parts that are connected to the magnetic circuit components have very simple geometries and have a cost-effective design, the fuel injector is particularly favorable in the production of the individual parts and in its assembly. The very short magnetic circuit operates very effectively at low losses and in this respect, it has best functioning properties. The construction according to the present invention makes it possible to produce a fuel injector having an overall length of <30 mm.

It is particularly advantageous to develop the sleeve element as a metallic, nonmagnetic intermediate part or as a ferritic component for a magnetic restrictor in the magnetic circuit. The sleeve element may be developed to be L-shaped or cylindrical in cross section, so that different fastening variants to the cover part come about.

Variants in length of the fuel injector according to the present invention are easily produced in large numbers by using connecting pieces, valve seat supports, valve needles and spacers that are of different lengths, and that are specifically formed.

### BRIEF DESCRIPTION OF THE DRAWING

FIG. 1 shows a fuel injector in two variants of embodiments according to the present invention, in the region of the electromagnetic circuit.

### DETAILED DESCRIPTION OF THE INVENTION

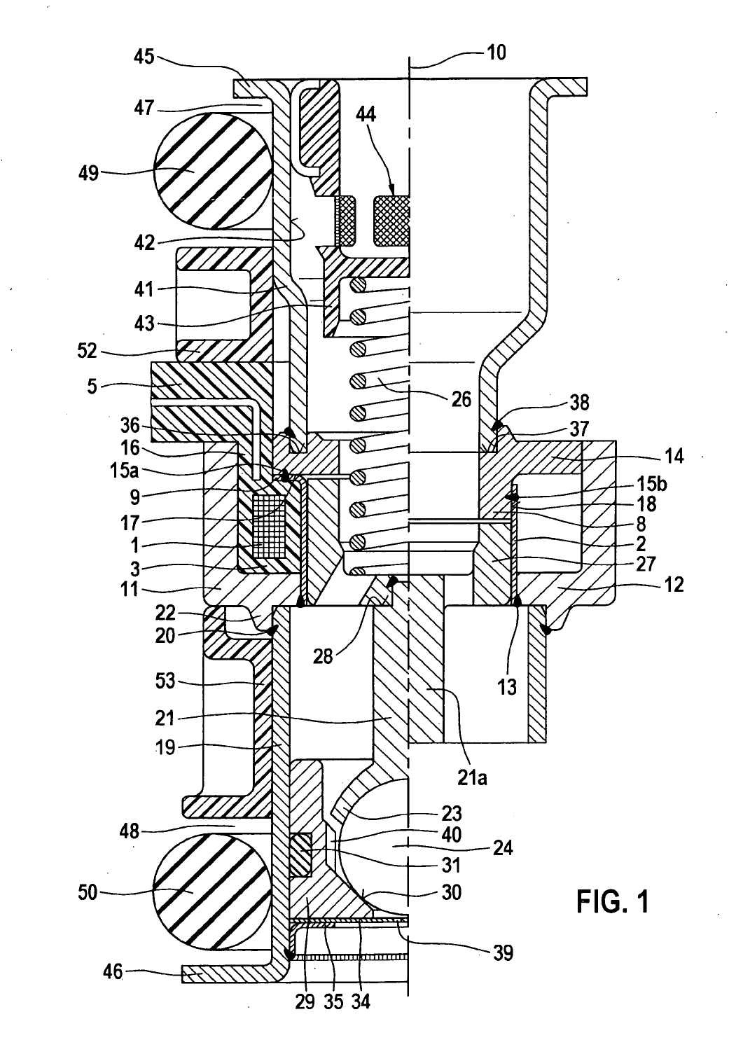

The electromagnetically operable valve, in the form of a fuel injector for fuel injection systems of mixture-compressing, spark-ignited internal combustion engines, shown in FIG. 1, for instance, has an electromagnetic circuit having a magnetic coil 1, which does not surround a tubular core used as a fuel inlet connection and internal pole, as is generally usual in the case of such fuel injectors. Rather, magnetic coil 1 surrounds a thin-walled cylindrical sleeve element 2. A coil shell 3 accommodates a winding of magnetic coil 1, coil shell 3 lying directly against an outer wall of sleeve element 2. Coil shell 3, made of plastic, goes over directly into an electrical plug connection 5, that is not shown in greater detail, and is extruded along with coil shell 3, and the electrical contacting of magnetic coil 1 takes place via plug connection 5.

Sleeve element 2 is positioned concentrically to a longitudinal valve axis 10, sleeve element 2 representing either a metallic, nonmagnetic intermediate part, which may be made, for instance, of stainless steel, or, as a ferritic component, it forms a magnetic restrictor in the magnetic circuit. Coil shell 3 having magnetic coil 1 is surrounded by an outer cup-shaped magnetic circuit component 11, which is a part of the valve housing. Sleeve element 2 is connected tightly and rigidly to component bottom 12 of magnetic circuit component 11, using a first welded seam 13. On the side opposite component bottom 12, a cover part 14 is inserted into magnetic circuit component 11, which is used as internal pole of the magnetic circuit. Cover part 14, in turn, is connected tightly and rigidly to sleeve element 2, using a second welded seam 15a or 15b. In this way, using cover part 14, sleeve element 2 and outer magnetic circuit component 11, a closed, sealed coil space is created, which is only interrupted in the region of the electrical contacting of magnetic coil 1 by a recess 16 in cover part 14.

In a first example embodiment (left side in FIG. 1) sleeve element 2 is L-shaped in cross section, and from the shape that is otherwise cylindrical, an annular collar 9 is bent off. Correspondingly, welded seam 15a (left side in FIG. 1) may be placed at a horizontal end face 17 of cover part 14. In this embodiment variant, cover part 14 runs like an extensively flat disk. In a second example embodiment (right side in FIG. 1), cover part 14 is also developed to be disk-shaped, but having a cylindrical extension 8, which extends into sleeve element 2, which makes it possible to apply welded seam 15b at a circumferential surface 18 of continuation 8 of cover part 14, which is parallel to the axis.

Downstream from magnetic circuit component 11, a thin-walled, tubular connecting part extends, which is developed here as valve seat support 19, which is connected rigidly to magnetic circuit component 11 via a third welded seam 20. Component bottom 12 of magnetic circuit component 11 has an annular extension 22 which projects away from magnetic circuit component 11 in such a way that welded seam 20 is able to be applied in this region without impairing magnetic coil 1 or other components, to connect with valve seat support 19. An axially movable valve needle 21 is situated in valve seat support 19. At downstream end 23 of valve needle 21, a spherical valve-closure member 24 is provided, made of metal or ceramic.

The operation of the fuel injector takes place electromagnetically. The electromagnetic circuit having magnetic coil 1, outer magnetic circuit component 11, cover part 14 and an armature 27 is used for axially moving valve needle 21, and therefore, for opening the fuel injector against the spring force of a restoring spring 26, and for closing the fuel injector. Cup-shaped armature 27 is developed as one part with a valve needle shaft 21a (right side in FIG. 1) or is set in at a stage 28 of valve needle shaft 21a and is there rigidly connected with it (left side in FIG. 1). The guidance of armature 27 during its axial motion takes place along the inner wall of sleeve element 2. A cylindrical valve seat body 29 which has a fixed valve seat 30, is tightly mounted by welding into the downstream end, facing away from magnetic coil 1, of valve seat support 19. Valve seat body 29 is made of metal or ceramic, and sealed using a sealing ring 31.

Spherical valve-closure member 24 of valve needle 21 interacts with valve seat 30 of valve-seat member 29, which is frustoconically tapered in the direction of flow. At its lower end face, valve seat member 29 is connected to a spray orifice disk 34, that is developed to be flat, for example, and to a holding disk 35 that is developed to be cup-shaped, for example, in a rigid and sealing manner by a welded seam that is developed, for example, using a laser. In spray orifice disk 34, at least one, but, for example, four, spray-discharge orifices 39 are provided that are formed by eroding or stamping, for example. In order to ensure a fuel supply going all the way to valve seat 30, a plurality of flow-through grooves 40 is provided peripherally in the region of a guidance section in valve seat body 29.

The positioning of cover part 14 in outer magnetic circuit component 11 and at sleeve element 2 is decisive for the lift of valve needle 21. When magnetic coil 1 is not energized, the one end position of valve needle 21 is established by the contact of valve-closure member 24 with valve seat 30 of valve seat body 29, while when magnetic coil 1 is energized, the other end position of valve needle 21 results from the contact of armature 27 with the lower end of cover part 14, which is provided there with a layer protecting against wear, for example.

The assembly of the fuel injector in the region of the magnetic circuit takes place in the following sequence. First, sleeve element 2 and cover part 14 are rigidly connected to each other via welded seams 15, 15a, 15b. At the same time, or subsequently, coil shell 3 having magnetic coil 1 is introduced into outer magnetic circuit component 11. Thereafter, these two assemblies are joined to each other until cover part 14 is correctly positioned in magnetic circuit component 11. The rigid connection of sleeve element 2 to magnetic circuit component 11 at the latter's component bottom 12 takes place using welded seam 13. Subsequently, valve seat support 19 is fastened to magnetic circuit component 11 using welded seam 20.

At the inflow end, cover part 14 is rigidly connected to a thin-walled connecting piece 41, using a fourth welded seam 38. Connecting piece 41 runs in a tubular manner, and in this context, it may be formed via steps at different places, specifically with respect to inside diameters, as may be inferred from FIG. 1. Variable lengths may be used for connecting pieces 41. Connecting piece 41 engages either with a groove 36 on cover part 14 (left side in FIG. 1), or rests on a shoulder 37 of cover part 14, flush with the internal bore of cover part 14 (right side in FIG. 1). In addition to restoring spring 26, an adjustment element 43 is fitted into a flow bore 42 of connecting piece 41, which extends concentrically with longitudinal valve axis 10 and is used to supply fuel in the direction of valve-seat 30. Adjustment element 43 is used to set the initial tension of restoring spring 26, resting against adjustment element 43, which, with its opposite end rests in turn against armature 27, an adjustment of the dynamic spray-discharge quantity being implemented by adjustment element 43, as well. A fuel filter 44 is integrated directly into adjustment element 43.

The fuel injector according to the present invention stands out by having an especially compact design in the region of the magnetic circuit as well as in the regions upstream and downstream of the magnetic circuit, so that a very small manageable fuel injector is created. Sleeve element 2 has a length of only 3.5 mm, for example. Both connecting piece 41 and valve seat support 19 are executed as thin-walled, deep-drawn components, which bound the fuel injector at the inflow and outflow ends by bent-over annular collars 45, 46. These annular collars 45, 46 in each case form a bounding of an annular groove 47, 48, into which in each case a sealing ring 49, 50 mounted, in the form of a ring for sealing the fuel injector from the outside (fuel rail, intake manifold).

The respectively other limitation of annular grooves 47, 48 fix spacers 52, 53, which are pushed circumferentially onto connecting piece 41 and valve seat support 19. Spacers 52, 53 are formed of plastic, for example, and have a structure that is highly stable because of comb-like hollow spaces reaching outwards, but have a very low mass in this context. FIG. 1 shows two variants of the fuel injector according to the present invention. Variants in length of the fuel injector are very simply produced in large numbers by using different length, specifically formed connecting pieces 41, valve seat supports 19, valve needles 21 and spacers 52, 53. Color coding of the fuel injectors is very simply possible using appropriately dyed spacers 52, 53. Plastic extrusion coating of the fuel injector may be omitted.

1-11. (canceled)

12. A fuel injector for a fuel injection system of an internal combustion engine, comprising:
an excitable actuator, wherein the actuator is an electromagnetic circuit having a magnetic coil, an outer magnetic circuit component, and a movable armature, wherein a coil space for the magnetic coil is bounded by the outer magnetic circuit component, a cover part and a thin-walled sleeve element;
a valve seat provided on a valve seat body; and
a valve-closure member interacting with the valve seat, wherein the valve-closure member is actuated by the movable armature.

13. The fuel injector as recited in claim 12, wherein the sleeve element is one of (a) metallic, nonmagnetic intermediate part, or (b) a ferritic component forming a magnetic restrictor in the magnetic circuit.

14. The fuel injector as recited in claim 12, wherein the cover part is rigidly connected to the sleeve element using a welded seam.

15. The fuel injector as recited in claim 14, wherein the sleeve element has a cylindrical portion and an annular collar bent off from the cylindrical portion in the circumferential direction such that the sleeve element has an L-shape in cross section and the welded seam is placed at the horizontal end face of the cover part.

16. The fuel injector as recited in claim 14, wherein the sleeve element has a cylindrical shape and the cover part is configured to have a cylindrical extension extending into the sleeve element, so that the welded seam is applied at a circumferential surface of the extension of the cover part extending parallel to a longitudinal valve axis of the fuel injector.

17. The fuel injector as recited in claim 14, wherein the outer magnetic circuit component is configured to be cup-shaped and has a component bottom, and wherein a region of the component bottom of the outer magnetic circuit component is rigidly connected to the sleeve element using a welded seam.

18. The fuel injector as recited in claim 14, wherein the inner wall of the sleeve element is configured to provide a precise guidance of the armature along the inner wall during an axial motion of the armature.

19. The fuel injector as recited in claim 14, wherein the outer magnetic circuit component is rigidly connected by a welded seam to a tubular connecting part configured as a valve seat support.

20. The fuel injector as recited in claim 19, wherein the component bottom of the magnetic circuit component has an annular extension projecting away from the magnetic circuit component in such a way that the welded seam is applied onto the annular extension.

21. The fuel injector as recited in claim 14, wherein a coil shell embedding the magnetic coil directly contacts the outer wall of the sleeve element.

22. The fuel injector as recited in claim 14, wherein the fuel injector has a total length of <30 mm.
